(19) United States
(12) Patent Application Publication
(10) Pub. No.: US 2016/0275383 A1
(43) Pub. Date: Sep. 22, 2016

(54) IMAGE FORMING CONTROL APPARATUS, IMAGE FORMING SYSTEM, AND METHOD OF CONTROLLING INFORMATION FOR IMAGE FORMATION

(71) Applicant: Itsuo Yukie, Tokyo (JP)

(72) Inventor: Itsuo Yukie, Tokyo (JP)

(73) Assignee: Ricoh Company, Ltd., Tokyo (JP)

(21) Appl. No.: 15/072,776

(22) Filed: Mar. 17, 2016

(30) Foreign Application Priority Data
Mar. 20, 2015 (JP) 2015058814
Feb. 29, 2016 (JP) 2016037425

(51) Int. Cl. G06K 15/02

(52) U.S. Cl. CPC G06K 15/1814; G06K 15/1803; G06K 15/1817; G06K 15/1836

(57) ABSTRACT

An image forming control apparatus, which includes a memory to store first recording medium information, obtains second recording medium information from an image forming apparatus, compares between the first recording medium information and the second recording medium information to generate a comparison result, and synchronizes between the first recording medium information and the second recording medium information based on the comparison result indicating that the first recording medium information and the second recording medium information do not match with each other.

### CROSS-REFERENCE TO RELATED APPLICATIONS

This patent application is based on and claims priority pursuant to 35 U.S.C. §119(a) to Japanese Patent Application Nos. 2015-058814, filed on Mar. 20, 2015, and 2016-037425, filed on Feb. 29, 2016, in the Japan Patent Office, the entire disclosure of which is hereby incorporated by reference herein.

### BACKGROUND

1. Technical Field

The present invention generally relates to an image forming control apparatus, an image forming system including the image forming control apparatus, a method of controlling information for image formation, and a non-transitory recording medium.

2. Description of the Related Art

Recently, production printing systems are widely used for large corporate offices or print shops. In the production printing system, in order to print high-quality images at high speeds, a control apparatus (digital front end) with at least one raster image processor (RIP) is provided between a client terminal and an image forming apparatus. The control apparatus includes a recording sheet database, which stores recording sheet information regarding a recording sheet to be used at each image forming apparatus. Each image forming apparatus, which forms an image based on the raster image transmitted from the control apparatus, includes a recording sheet database that stores recording sheet information regarding a recording sheet to be used at the image forming apparatus. While such recording sheet information may be set according to the user preference, the recording sheet information should be matched between the control apparatus and the image forming apparatus to obtain an image as specified by the user.

### SUMMARY

Example embodiments of the present invention include an image forming control apparatus coupled to an image forming apparatus through a network and to control the image forming apparatus to form an image. The image forming control apparatus includes a memory to store first recording medium information including, for each one of a plurality of entries of recording medium to be formed with an image, basic recording medium information that is previously determined by a type of recording medium and extended recording medium information that is previously determined by property of the image to be formed on the recording medium. The image forming control apparatus obtains second recording medium information from the image forming apparatus, the second recording medium being stored in a memory of the image forming apparatus and including for each one of a plurality of entries of recording medium to be formed with an image, basic recording medium information that is previously determined by a type of recording medium and extended recording medium information that is previously determined by property of the image to be formed on the recording medium, compares between the first recording medium information and the second recording medium information to generate a comparison result, and synchronizes between the first recording medium information and the second recording medium information based on the comparison result indicating that the first recording medium information and the second recording medium information do not match with each other.

Example embodiments of the present invention include an image forming system including the above-described image forming control apparatus and one or more image forming apparatuses to be controlled by the image forming control apparatus.

Example embodiments of the present invention include a method for controlling information, performed by the image forming control apparatus, and a non-transitory recording medium storing the control program.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a print system according to an embodiment of the present invention;

FIG. 2 is a hardware configuration of a client terminal and a print control apparatus of the print system of FIG. 1;

FIG. 3 is a schematic block diagram illustrating a hardware configuration of a printer of the print system of FIG. 1;

FIG. 4 is a schematic block diagram illustrating a functional configuration of the print system of FIG. 1;

FIG. 5A is a conceptual diagram illustrating a print control management table;

FIG. 5B is a conceptual diagram illustrating a printer management table;

FIG. 6 is an illustration of an example synchronization instruction screen;

FIGS. 7 and 8 illustrate a flowchart illustrating operation of synchronizing the recording sheet information, according to an embodiment of the present invention;

FIG. 9 is a flowchart illustrating operation of synchronizing recording sheet information based on recording sheet information for the print control apparatus, according to an embodiment of the present invention;

FIG. 10A illustrates sheet information of the print control apparatus before synchronization, FIG. 10B illustrates sheet information of the print control apparatus before synchronization, FIG. 10C illustrates sheet information of the print control apparatus after synchronization, and FIG. 10D illustrates sheet information of the print control apparatus after synchronization, in performing the operation of FIG. 9;

FIG. 11 is a flowchart illustrating operation of synchronizing recording sheet information based on recording sheet information for the printer, according to an embodiment of the present invention;

FIG. 12A illustrates sheet information of the print control apparatus before synchronization, FIG. 12B illustrates sheet information of the print control apparatus before synchronization, FIG. 12C illustrates sheet information of the print control apparatus after synchronization, and FIG. 12D illustrates sheet information of the print control apparatus after synchronization, in performing the operation of FIG. 11;

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

Referring to the drawings, an embodiment of the present invention is described.

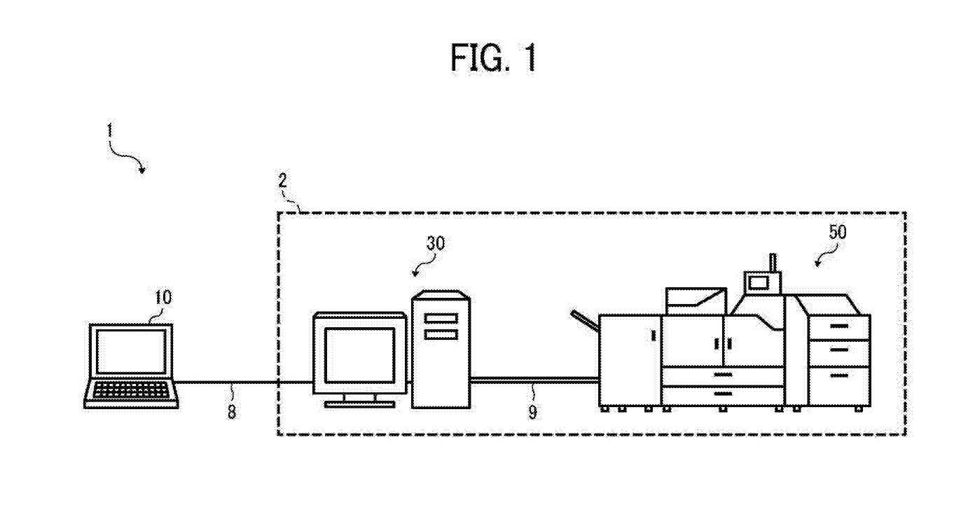

FIG. 1 is a schematic block diagram illustrating a print system according to an embodiment of the present invention. As illustrated in FIG. 1, the print system 1, which is an example of image forming system, includes a client terminal 10 and a print processing system 2. The print processing system 2, which is an example of image forming processing system, includes a print control apparatus 30 and a printer 50. In this example, the print control apparatus 30 is one example of image forming control apparatus, and the printer 50 is one example of image forming apparatus. The print control apparatus 30 in this example operates as a digital front end processor server. The client terminal 10 and the print control apparatus 30 are connected through a first communication network 8 such as a local area network (LAN) to be communicable with each other. The print control apparatus 30 and the printer 50 are connected through a second communication network 9 such as a dedicated network to be communicable with each other. The following disclosure describes the example case of performing production printing with the print system 1, however, the print system 1 may perform any desired processing other than production printing.

The client terminal 10 is a personal computer (PC), which views or edits print data, as example target data for image formation. The print control apparatus 30 is a server computer. More specifically, the print control apparatus 30 generates bit-map data for printing based on print data (such as postscript data) transmitted from the client terminal 10, and transmits the generated bit-map data with an instruction for printing to the printer 50. The printer 50 prints an image on a recording sheet based on the bit-map data transmitted from the print control apparatus 30.

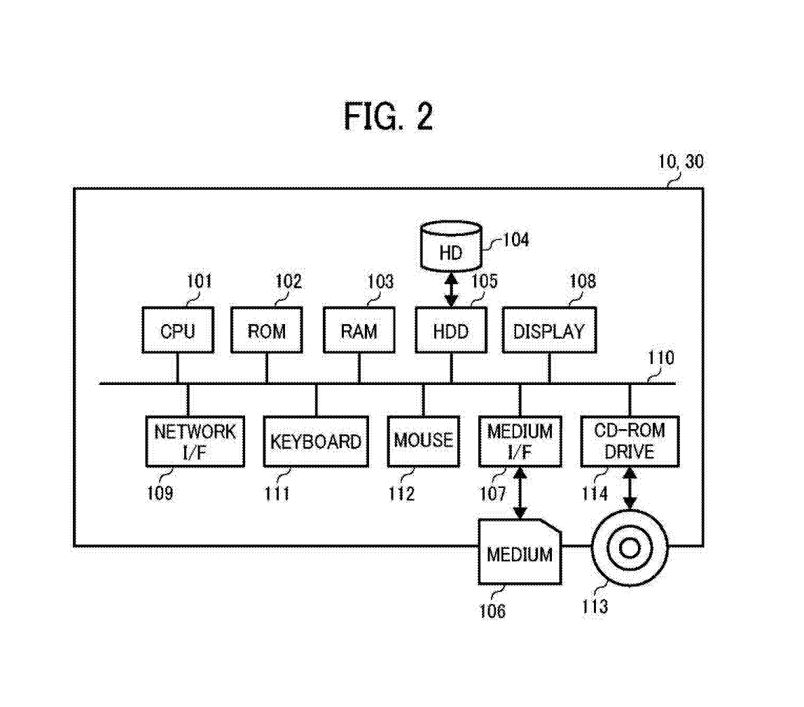

Referring to FIG. 2, a hardware configuration of the client terminal 10 and the print control apparatus 30 is described according to an embodiment of the present invention. FIG. 2 is a hardware configuration of the client terminal 10 and the print control apparatus 30 according to the embodiment. In this embodiment, the client terminal 10 and the print control apparatus 30 is implemented by a general-purpose computer as illustrated in FIG. 2.

As illustrated in FIG. 2, the client terminal 10 (the print control apparatus 30) includes a central processing unit (CPU) 101, a read only memory (ROM) 102, a random access memory (RAM) 103, a hard disk (HD) 104, a hard disk drive (HDD) 105, a medium interface (I/F) 107, a display 108, a network I/F 109, a keyboard 111, a mouse 112, and a Compact Disc Read Only Memory (CD-ROM) drive 114, which are electronically connected through a bus line 110 such as an address bus or a data bus. The CPU 101 controls entire operation of the client terminal 10. The ROM 102 stores a program for operating the CPU 101, such as an initial program loader (IPL). The RAM 203 operates as a work area for the CPU 101. The HD 104 stores various types of data, such as a control program. The HDD 105 controls reading/writing of various types of data from/to the HD 104 under control of the CPU 101. The medium I/F 107 controls reading/writing (storage) of data from/to a recording medium 106 such as a flash memory. The display 108 displays various types of information such as a cursor, a menu, a window, characters, or an image. The network I/F 109 transmits data using such as the communication network 8. The keyboard 111 includes a plurality of keys for entering characters, numerals, and various instructions. The mouse 112 allows a user to select and execute various instructions, select a processing target, or move the cursor. The CD-ROM drive 114 controls reading/writing of various types of data from/to a CD-ROM 113 serving as an example of a removable recording medium.

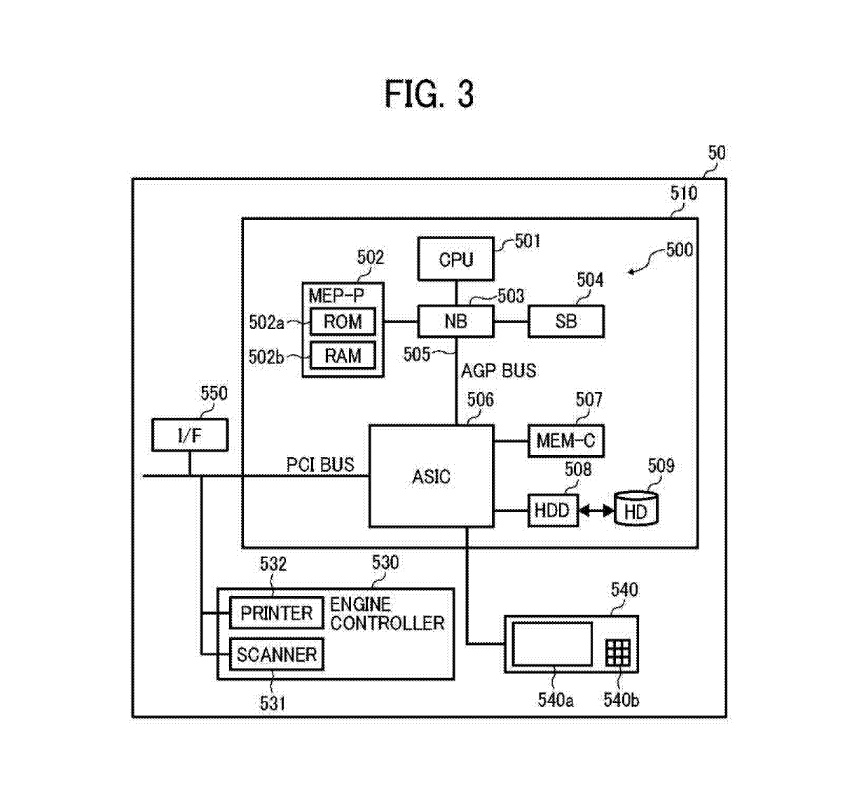

Referring to FIG. 3, a hardware configuration of the printer 50 is described according to an embodiment of the present invention. FIG. 3 is a schematic block diagram illustrating a hardware configuration of the printer 50 according to the embodiment.

The printer 50 includes a controller 510, an engine controller 530, an operation panel 540, and a communication interface 550. The engine controller 530 includes a scanner controller 531 and a printer controller 532. The operation panel 540 includes a display 540a and various keys 540b. The operation panel 540 displays current settings or a selection screen, and is provided with a touch panel for receiving a user input. The keys 540b, which include a ten key and a Start key, receives a user instruction for setting various image forming parameters such as image density parameter. The controller 510 controls entire operation of the printer 50. In example operation, the controller 510 controls drawing, communication, or user inputs to the operation panel 540. The scanner controller 531 and the printer controller 532 each perform various image processing, such as error diffusion or gamma conversion.

In response to an instruction to select a specific application through the operation panel 540, the printer 50 selectively performs storing of document data, copying, printing, and transmitting facsimile. More specifically, in response to the selected application, the printer 50 changes its operating mode to, for example, a document box mode, a copy mode, a printer mode, or a facsimile mode.

The controller 510 includes a central processing unit (CPU) 501, a system memory (MEM-P) 502, a north bridge (NB) 503, a south bridge (SB) 504, an Application Specific Integrated Circuit (ASIC) 506, a local memory (MEM-C) 507, a HDD 508, and a HD 509. The NB 503 and the ASIC 506 are connected through an Accelerated Graphics Port (AGP) bus 505.

The CPU 501 controls entire operation of the printer 50. The NB 503 connects the CPU 501, with the MEM-P 502, SB 504, and AGP bus 505. The NB 503 includes a memory controller for controlling reading or writing of various data with respect to the MEM-P 502, a Peripheral Component Interconnect (PCI) master, and an AGP target.

The MEM-P 502 includes a ROM 502a that stores program and data for operating the controller 510, and a RAM 502b that deploys the program and data or stores drawing data for printing. The program stored in the RAM 502b may be installed in any desired recording medium, such as a CD-ROM, FD, CD-R, or DVD, in a format installable and executed by a computer, for distribution. The SB 502 connects the NB 503 with a PCI bus or a peripheral device. The ASIC 506 is an integrated circuit (IC) dedicated to image processing, and connects the AGP bus 505, PCI bus, HDD 508, and MEM-C 507. The ASIC 506 includes a PCI target, an AGP master, an arbiter (ARB), a memory controller for controlling the MEM-C 507, a plurality of direct memory access controllers (DMACs) capable of rotating image data with a hardware logic, and a PCI unit that transfers data between the scanner controller 531 and the printer controller 532 through the PCI bus. The ASIC 506 may be connected to a Universal Serial Bus (USC) interface, or the Institute of Electrical and Electronics Engineers 1394 (IEEE1394) interface.

The MEM-C 507 is a local memory, which is used as a buffer for image data to be copied or code image. The HD 509 stores various image data, font data for printing, and form data. The HDD 508 reads or writes various data from or to the HD 509 under control of the CPU 501. The AGP bus 505 is a bus interface for a graphics accelerator card. Through directing accessing the MEM-P 502 by high-throughput, the AGP bus 505 can be accelerated.

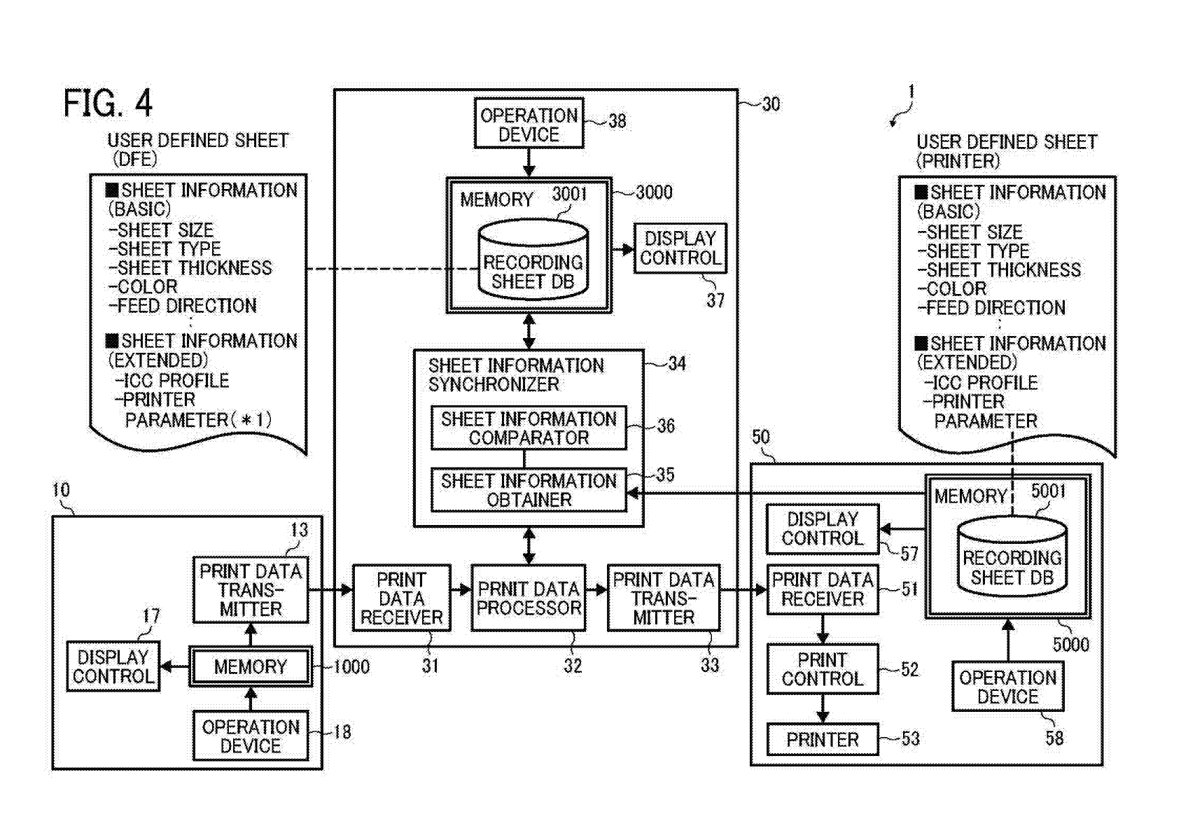

Referring to FIG. 4, a functional configuration of the print system 1 is described according to the embodiment. FIG. 4 is a schematic block diagram illustrating a functional structure of the print system of FIG. 1.

<Functional Configuration of Client Terminal>

The client terminal 10 includes a print data transmitter 13, a display control 17, and an operation device 18. These units are functions that are implemented by or that are caused to function by operating any of the hardware components illustrated in FIG. 2 in cooperation with the instructions of the CPU 101 according to the control program expanded from the HD 104 to the RAM 103. The client terminal 10 further includes a memory 1000, which may be implemented by the RAM 103 or the HD 104 of FIG. 2.

The display control 17, which may be implemented by the instructions of the CPU 101, causes the display 108 to display various data such as print data, which is generated using application installed onto the client terminal 10. For example, the client terminal 10 may generate print data in the form of postscript or other page description language (PDL).

The operation device 18, which corresponds to the instructions of the CPU 101, receives a user input through the keyboard 111 or the mouse 112. The memory 1000 stores therein various data such as the print data.

The print data transmitter 13, which may be implemented by the network I/F 109 operating under control of the CPU 101, transmits the print data, which is created at the client terminal 10, to the print control apparatus 30 through the first communication network 8.

<Functional Configuration of Print Control Apparatus>

The print control apparatus 30 includes a print data receiver 31, a print data processor 32, a print data transmitter 33, a sheet information synchronizer 34, a display control 37, and an operation device 38. The sheet information synchronizer 34 includes a sheet information obtainer 35 and a sheet information comparator 36. These units are functions that are implemented by or that are caused to function by operating any of the hardware components illustrated in FIG. 2 in cooperation with the instructions of the CPU 101 according to the control program expanded from the HD 104 to the RAM 103. The print control apparatus 30 further includes a memory 3000, which may be implemented by the RAM 103 or the HD 104 of FIG. 2.

The print data receiver 31 receives the print data from the client terminal 10 through the second communication network 8, that is, the LAN 8.

The print data processor 32 processes the print data, for example, by applying various processing, such as screening and color conversion, with a raster image processor (RIP). The screening is a process for rasterizing or converting the print data in PDL to bitmap data, which is a series of dots at a resolution of an output device.

The print data transmitter 33 transmits the print data to the printer 30 through the second communication network 9, that is, the dedicated network 9.

The sheet information synchronizer 34 manages recording sheet information, which is stored in a recording sheet DB 3001 of the print control apparatus 30. As described below, the recording sheet information is stored in the form of a print control management table. The sheet information obtainer 35 obtains, from a memory 5000 of the printer 50, a printer management table storing recording sheet information that is set at the printer 50. The sheet information comparator 36 compares between the printer management table obtained by the sheet information obtainer 35, and the print control management table stored in the memory 3000 of the print control apparatus 30, to determine whether the recording sheet information match.

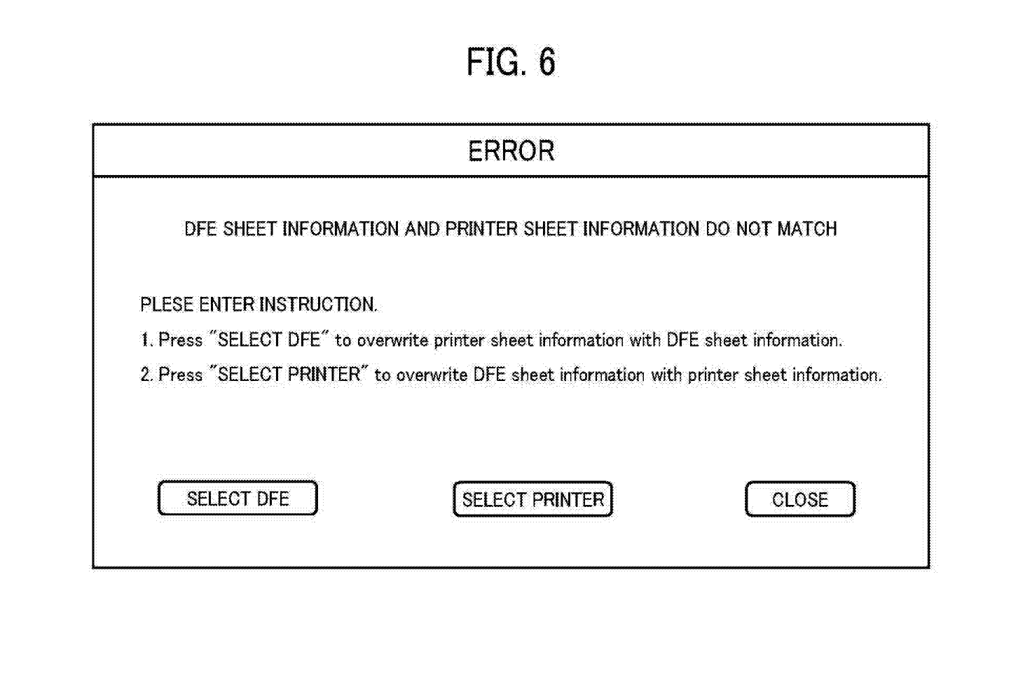

If a comparison by the sheet information comparator 36 indicates that the recording sheet information does not match, the sheet information synchronizer 34 modifies the sheet information of the printer 50 so as to match the sheet information of the print control apparatus 30 or vice versa. The display control 37 causes the display 108 of the print control apparatus 30 to display an instruction screen, as illustrated in FIG. 6. The operation device 38 accepts an instruction to newly add sheet information, edit the existing sheet information, or delete specific sheet information, which is input by the user through the keyboard 111 or the mouse 112.

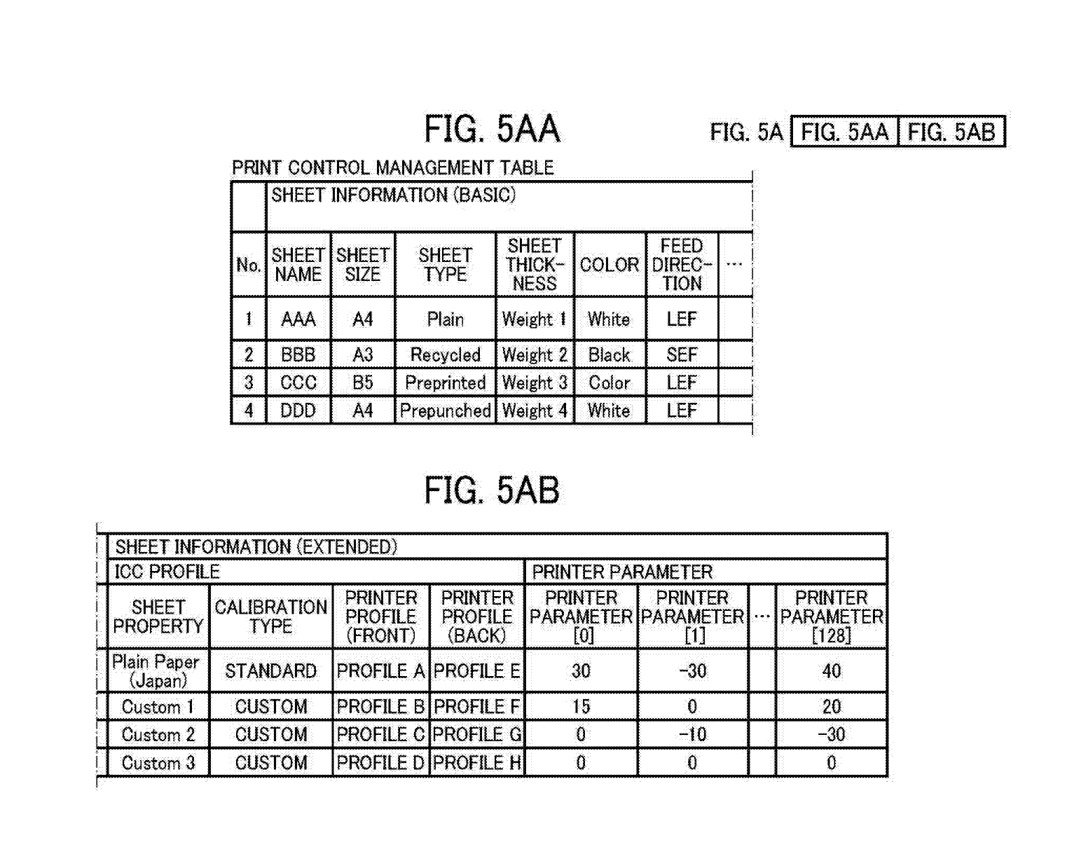

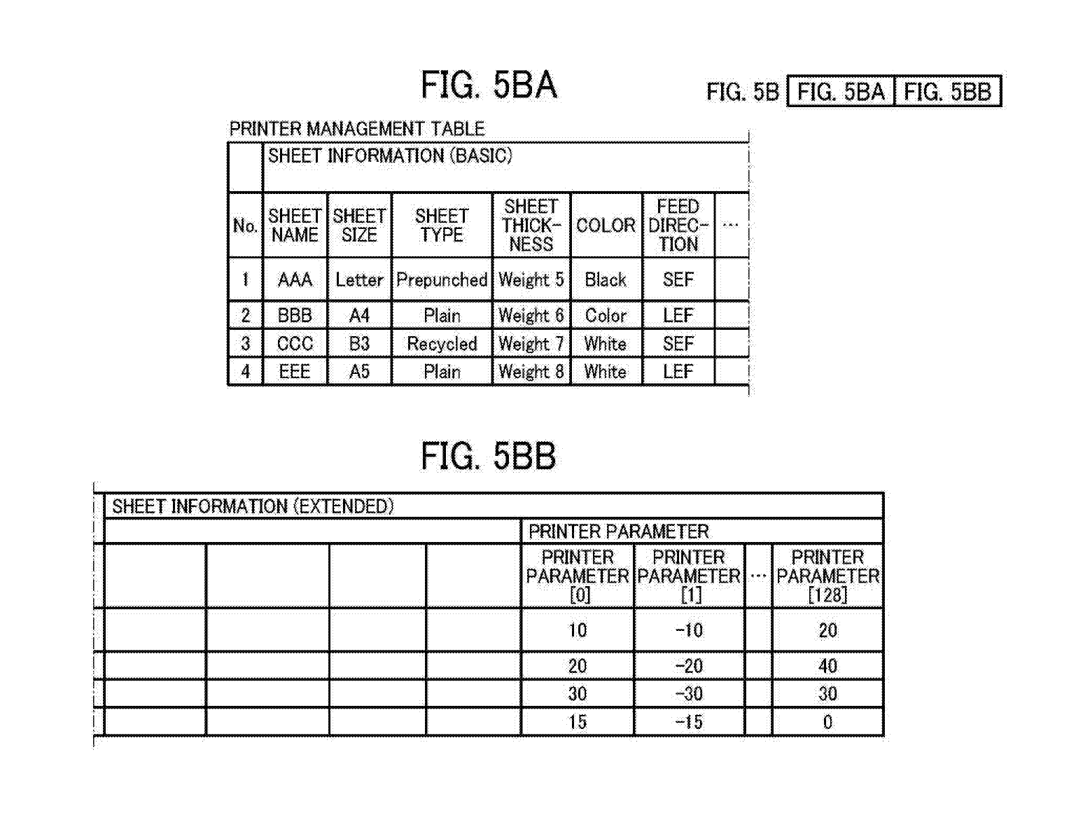

The memory 3000 includes the recording sheet DB 3001. The recording sheet DB 3001 is implemented by the print control management table of FIG. 5A. The print control management table of FIG. 5A manages basic recording sheet information. The basic recording sheet information is standard information, which is previously determined by type of recording sheet, and includes a “sheet name”, “sheet size”, “sheet type”, “sheet thickness”, “color”, and “feeding direction”. The print control management table of FIG. 5A further includes extended recording sheet information. The extended recording sheet information includes ICC profile setting information, and printer parameter information, which may be set by the user according to a property of the image to be formed. In this embodiment, the recording sheet may be any desired recording medium, such as paper or a film.

The ICC profile setting information is previously determined according to a property of an image to be printed on the recording sheet and includes “sheet property type”, “calibration type”, and “printer profile”. The sheet property type indicates a specific type of reference curve of the recording sheet. As the sheet property type, a default setting or a custom setting may be specified. For example, the user may generate a reference curve for a custom-type recording sheet, and set the generated reference curve as custom.

The calibration type indicates a specific type of calibration curve for correcting the reference curve of the recording sheet. As the calibration type, a standard setting or a custom setting may be specified. For example, the user may generate a calibration curve for a custom-type recording sheet, and set the generated calibration curve as custom.

The printer profile indicates a specific printer profile to be used for correcting color at a destination printer. The printer parameter information includes various printer parameter values including, for example, image position adjustment parameter, sheet transfer/sheet discharge adjustment parameter, and post-processing (such as folding) adjustment parameter.

The printer parameters are to be used by the printer 50 in printing, and include various parameter values for correcting a transfer distance between the recording sheets, a fixing temperature, and image position. Since this information is specific to each printer 50, the printer parameter information cannot be set at the print control apparatus 30, as indicated by (*1) of FIG. 4.

<Functional Configuration of Printer>

The printer 50 includes a print data receiver 51, a print controller 52, a printer 53, and an operation device 58. These units are functions that are implemented by or that are caused to function by operating any of the hardware components illustrated in FIG. 3 in cooperation with the ASIC 506, the instructions of the CPU 501 according to the print control program expanded from the HD 509 to the RAM 502b. The printer 50 further includes the memory 5000, which may be implemented by the RAM 502b and the HD 509 of FIG. 3.

The print data receiver 51, which may be implemented by the communication I/F 550, receives print data from the print control apparatus 30 through the second communication network 9 such as the dedicated network 9. The print controller 52 controls timing for printing print data received from the print control apparatus 30, or controls various print settings based on the printer parameters that are set by the user. The printer 53 prints an image based on the received print data. The display control 57 causes the operation panel 540 to display such as an instruction screen of FIG. 6. The operation device 58 accepts an instruction to newly add sheet information, edit the existing sheet information, or delete specific sheet information, which is input by the user through the operation panel 540.

The memory 5000 includes the recording sheet DB 5001. The recording sheet DB 5001 is implemented by the printer management table of FIG. 5B. The printer management table of FIG. 5B manages basic recording sheet information and extended recording sheet information, in a substantially similar manner for the print control management table of FIG. 5A.

In the print control management table of FIG. 5A, the basic recording sheet information and the ICC profile setting information of the extended recording sheet information may be newly added, edited, or deleted, through the operation device 38 of the print control apparatus 30. However, the printer parameter information of the extended recording sheet information in the print control management table of FIG. 5A cannot be set through the operation device 38 of the print control apparatus 30, as the printer parameter information is specific to each printer 50 and can only be set at the printer 50.

In the print management table of FIG. 5B, the basic recording sheet information and the printer parameter information of the extended recording sheet information may be newly added, edited, or deleted, through the operation device 58 of the printer 50. However, the ICC profile setting information of the extended recording sheet information cannot be set through the operation device 58 of the printer 50, as the ICC profile setting information can only be set at the print control apparatus 30.

The basic recording sheet information and the printer parameters of the extended recording sheet information should match between the print control management table of FIG. 5A and the printer management table of FIG. 5B. For this reason, the sheet information comparator 36 compares this information (basic recording sheet information and printer parameter information) between the print control apparatus 30 and the printer 50. The ICC profile setting information of the extended recording sheet information cannot be modified, for example, to be synchronized between the print control management table and the printer management table. For this reason, the sheet information comparator 36 does not compare the ICC profile setting information.

Referring to FIG. 6, an example of synchronization instruction screen is described. FIG. 6 illustrates an example synchronization instruction screen. If the sheet information does not match between the recording sheet DB 3001 of the print control apparatus 30 and the recording sheet DB 5001 of the printer 50, the print control apparatus 30 causes the display 108 to display the synchronization instruction screen of FIG. 6. The instruction screen of FIG. 6 lists two options to correct inconsistency between the print control apparatus (DFE) 30 and the printer 50, and the option to postpone the instruction. In response to selection of the “SELECT DFE” key, the recording sheet DB 5001 of the printer 50 is updated so as to match the sheet information of the recording sheet DB 3001 of the print control apparatus 30. On the other hand, in response to selection of the “SELECT PRINTER” key, the recording sheet DB 3001 of the print control apparatus 30 is updated so as to match the sheet information of the recording sheet DB 5001 of the printer 50. In response to selection of the “CLOSE” key, the print control apparatus 30 closes the instruction screen, without synchronizing the recording sheet information between the print control apparatus 30 and the printer 50.

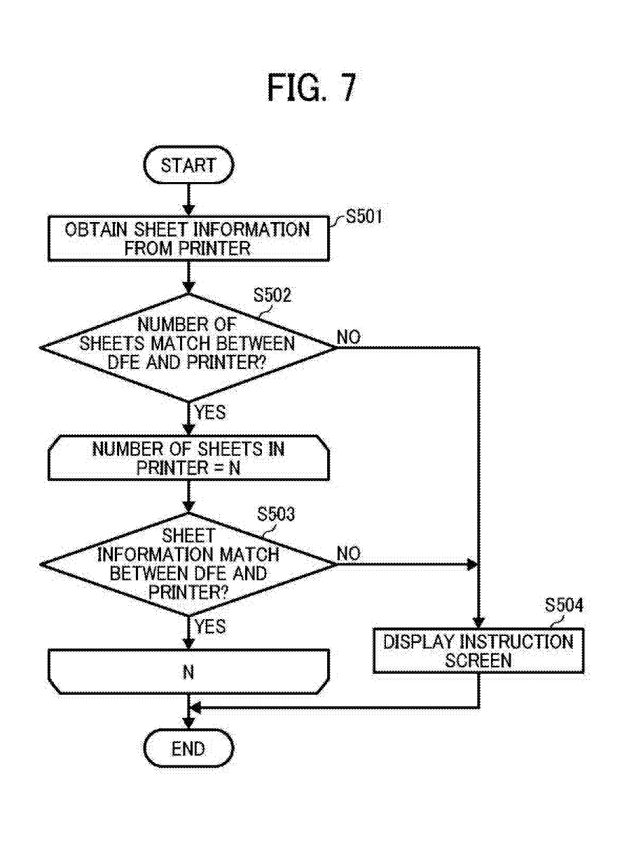

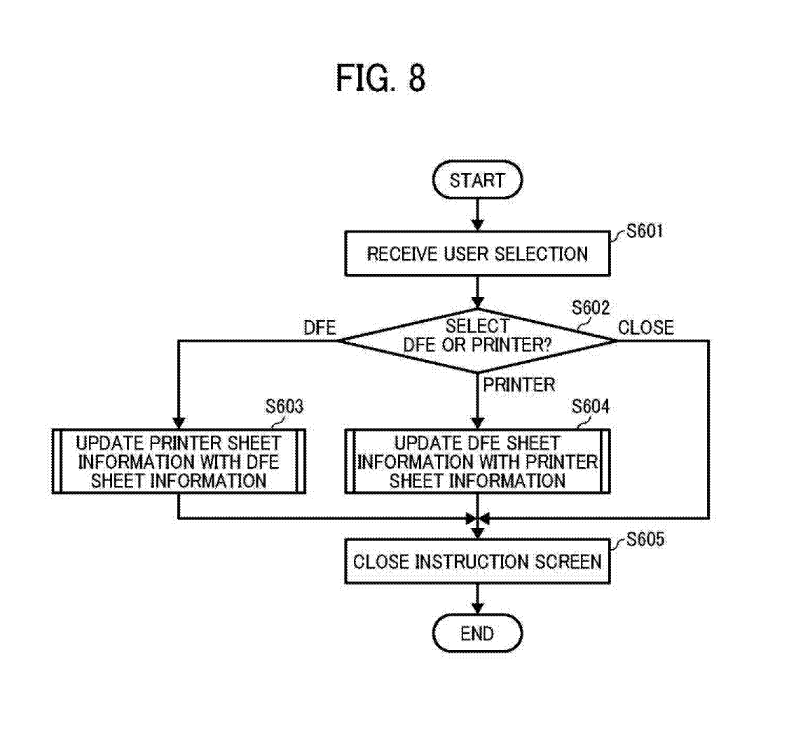

Now, operation of synchronizing the recording sheet information in the print system 1 is described according to the embodiment of the present invention. FIGS. 7 and 8 illustrate a flowchart illustrating operation of synchronizing the recording sheet information, according to the embodiment.

Referring to FIG. 7, upon execution of the print control apparatus 30, at S501, the sheet information obtainer 35 obtains the sheet information stored in the recording sheet DB 5001 of the printer 50. For example, the sheet information obtainer 35 sends a request for sheet information to the printer 50. In response to the request, the printer 50 transmits the sheet information, read from the memory 5000, to the print control apparatus 30. At S502, the sheet information comparator 36 compares a number of entries registered as the sheet information between the recording sheet DB 3001 and the recording sheet DB 5001.

When the number of entries of the sheet information match between the print control apparatus 30 and the printer 50 (“YES” at S502), the operation proceeds to S503 to perform data comparison for each one of the entries. At S503, the sheet information comparator 36 compares the recording sheet information between the print control apparatus 30 and the printer 50 for the same entry assigned with the same ID (such as the same sheet name). This step of comparing the recording sheet information is repeated for all of the entries (N).

More specifically, for the firstly selected entry, the recording sheet information is compared between the print control apparatus 30 and the printer 50. Based on a comparison, if the recording sheet information match between the print control apparatus 30 and the printer 50 for the entry for comparison (“YES” at S503), the operation proceeds to compare for a next selected entry. In contrary, if the recording sheet information does match between the print control apparatus 30 and the printer 50 for the entry for comparison (“NO” at S503), the operation proceeds to S504. Referring back to S502, when the number of entries of the sheet information does not match between the print control apparatus 30 and the printer 50 (“NO” at S502), or the recording sheet information of at least one entry does not match (“NO” at S503), the operation proceeds to S504.

At S504, the sheet information synchronizer 34 instructs the display control 37 to display a synchronization instruction screen, such as the instruction screen of FIG. 6, and the operation ends. In response to the instruction, the display control 37 causes the display 108 to display the synchronization instruction screen. The operation device 38 start monitoring a user input.

Referring to FIG. 8, at S601, the operation device 38 receives a user instruction through the synchronization instruction screen of FIG. 6. At S602, the operation device 38 analyzes the user instruction, that is, selection of the specific key, to determine specific processing to be performed.

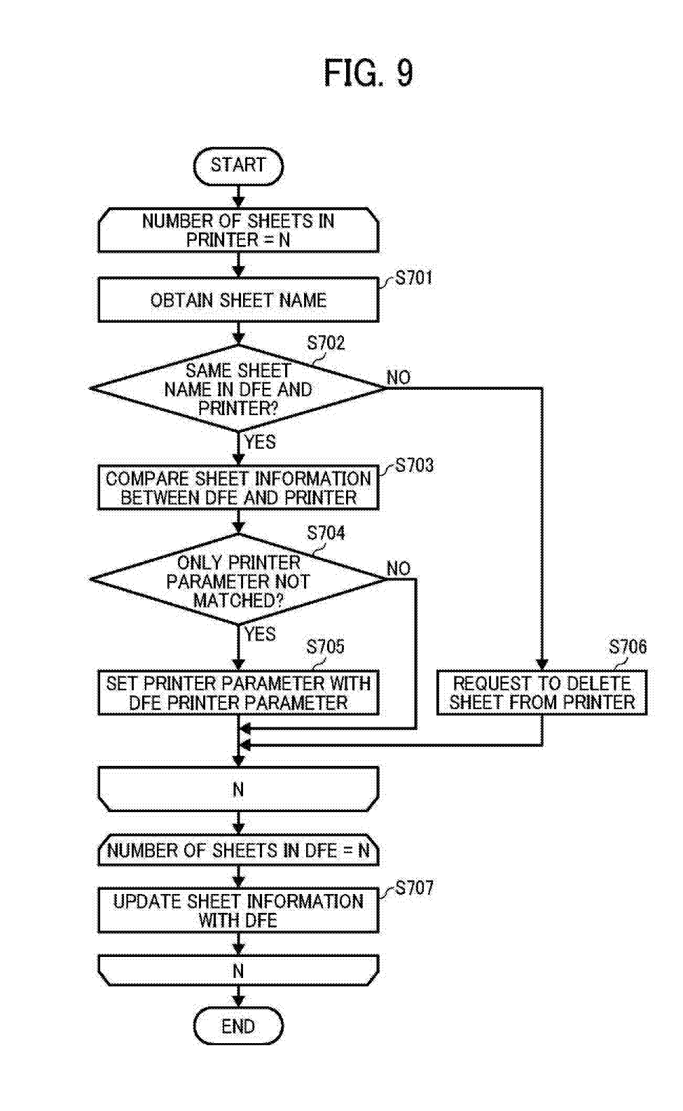

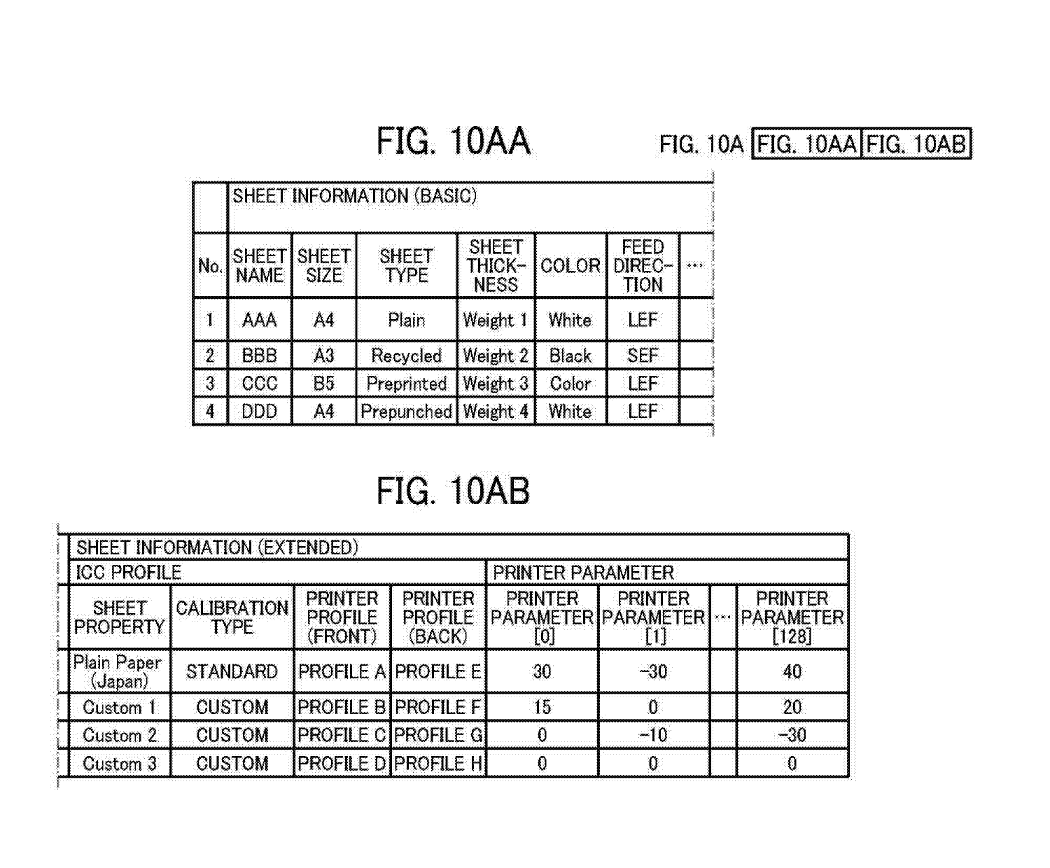

In response to selection of the “SELECT DFE” key (“DFE” at S602), the operation proceeds to S603. At S603, the operation device 38 instructs the sheet information synchronizer 34 to update the sheet information in the printer 50 so as to match the sheet information in the print control apparatus 30. The sheet information synchronizer 34 performs data synchronization based on the sheet information of the print control apparatus 30, and the operation proceeds to S605. The operation of synchronization at S603 is described in detail referring to FIG. 9.

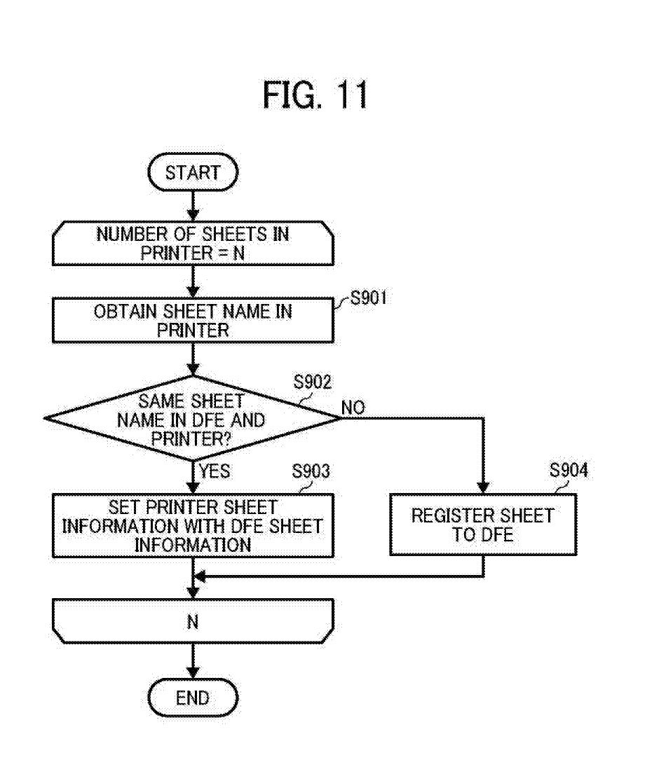

In response to selection of “SELECT PRINTER” key (“PRINTER” at S602), the operation proceeds to S604. At S604, the operation device 38 instructs the sheet information synchronizer 34 to update the sheet information in the print control apparatus 30 so as to match the sheet information in the printer 50. The sheet information synchronizer 34 performs data synchronization based on the sheet information of the printer 50, and the operation proceeds to S605. The operation of synchronization at S604 is described in detail referring to FIG. 11.

In response to selection of “CLOSE” key (“CLOSE” at S602), the operation proceeds to S605, without instructing the sheet information synchronizer 34 to perform synchronization operation. At S605, the operation device 38 closes the synchronization instruction screen of FIG. 6, and the operation ends. In such case, the user may check the recording sheet DB for the print control apparatus 30 or the printer 50 to correct information. Alternatively, the “CLOSE” key does not have to be provided to force the user to select either the DFE or printer.

Now, operation of synchronizing the recording sheet information between the print control apparatus 30 and the printer 50, performed by the print system 1, is described according to the embodiment. FIG. 9 is a flowchart illustrating operation of synchronizing the recording sheet information based on the recording sheet information for the print control apparatus 30.

At S701, the sheet information comparator 36 obtains a sheet name of the recording sheet in the recording sheet information stored in the printer 50. At S702, the sheet information comparator 36 determines whether the sheet name exists in the sheet information stored in the print control apparatus 30, which is the same as that of the sheet information obtained at S701. When the recording sheet information of the print control apparatus 30 includes an entry with the sheet name that is the same as the sheet name of the recording sheet information of the printer 50 (“YES” at S702), the operation proceeds to S703.

At 703, the sheet information comparator 36 compares the sheet information between the print control apparatus 30 and the printer 50 for the entry with the same sheet name. At S704, the sheet information comparator 36 determines whether only the printer parameter information differs between the sheet information of the print control apparatus 30 and the sheet information of the printer 50 for the entry with the same sheet name.

That is, of the recording sheet information of the same sheet name entry being compared, the basic recording sheet information such as the sheet name, sheet size, sheet type, thickness, color, and feeding direction are the same between the print control apparatus 30 and the printer 50. However, when only the printer parameter information differs between the print control apparatus 30 and the printer 50 (“YES” at S704), the operation proceeds to S705.

At S705, the sheet information synchronizer 34 overwrites the printer parameter information of the print control apparatus 30, with the printer parameter information of the printer 50 for that entry. In this way, the printer parameter information that reflects the most updated printer parameters at the printer 50 is overwritten onto the printer parameter information of the print control apparatus 30.

Referring back to S702, when the sheet information of the print control apparatus 30 does not have an entry with the same sheet name as that of the sheet information of the printer 50 that is obtained at S701 (“NO” at S702), the operation proceeds to S706. At S706, the sheet information synchronizer 34 requests the printer 50 to delete the subjected entry of the sheet information from the recording sheet DB 5001. The printer 50 deletes the entry of the sheet information from the recording sheet DB 5001. S701 to S705, or S701 to S706, is performed for each one of the entries of the sheet information obtained from the printer 50.

At S707, the sheet information synchronizer 34 requests the printer 50 to update the sheet information stored in the printer 50, with the sheet information stored in the print control apparatus 30. Accordingly, the sheet information stored in the recording sheet DB 5001 of the printer 50 is synchronized with the sheet information stored in the recording sheet DB 3001 of the print control apparatus 30. S707 is performed for each one of the entries of the sheet information stored in the print control apparatus 30. Accordingly, the sheet information is synchronized between the print control apparatus 30 and the printer 50, based on the sheet information of the print control apparatus 30. However, only in case the printer parameter information differs, the printer parameter information stored in the printer 50 is reflected to the printer parameter information of the print control apparatus 30.

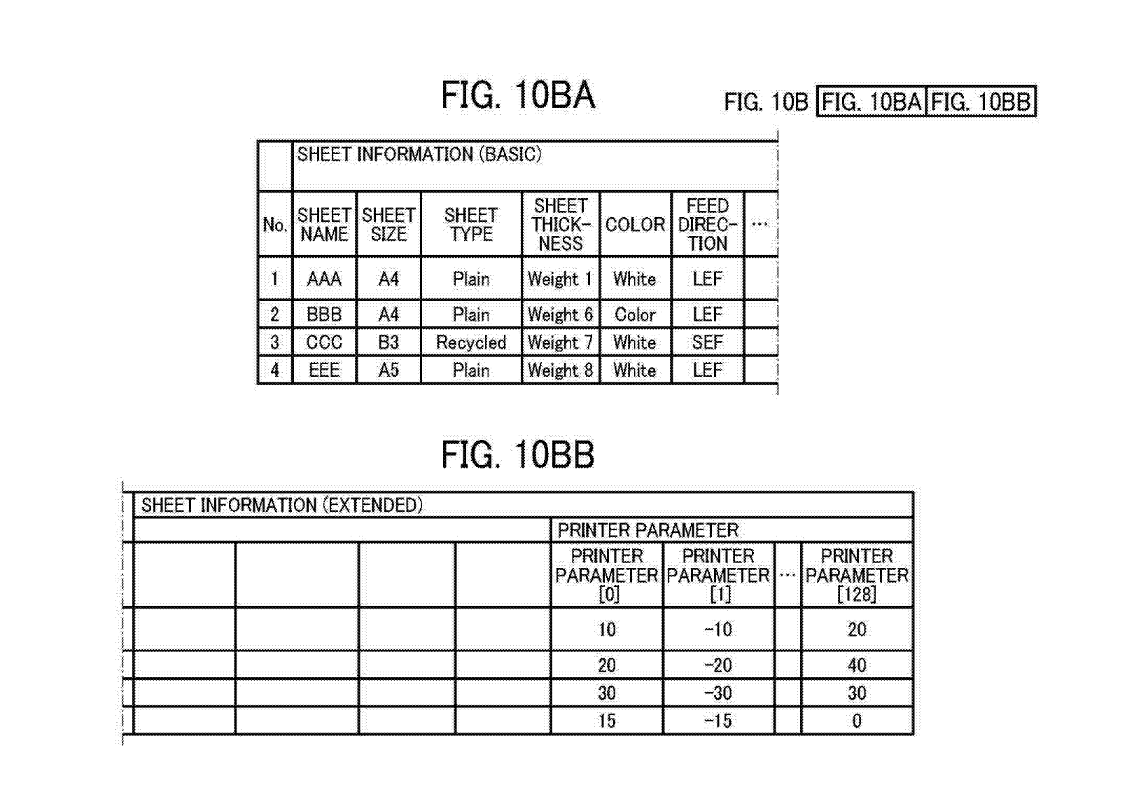

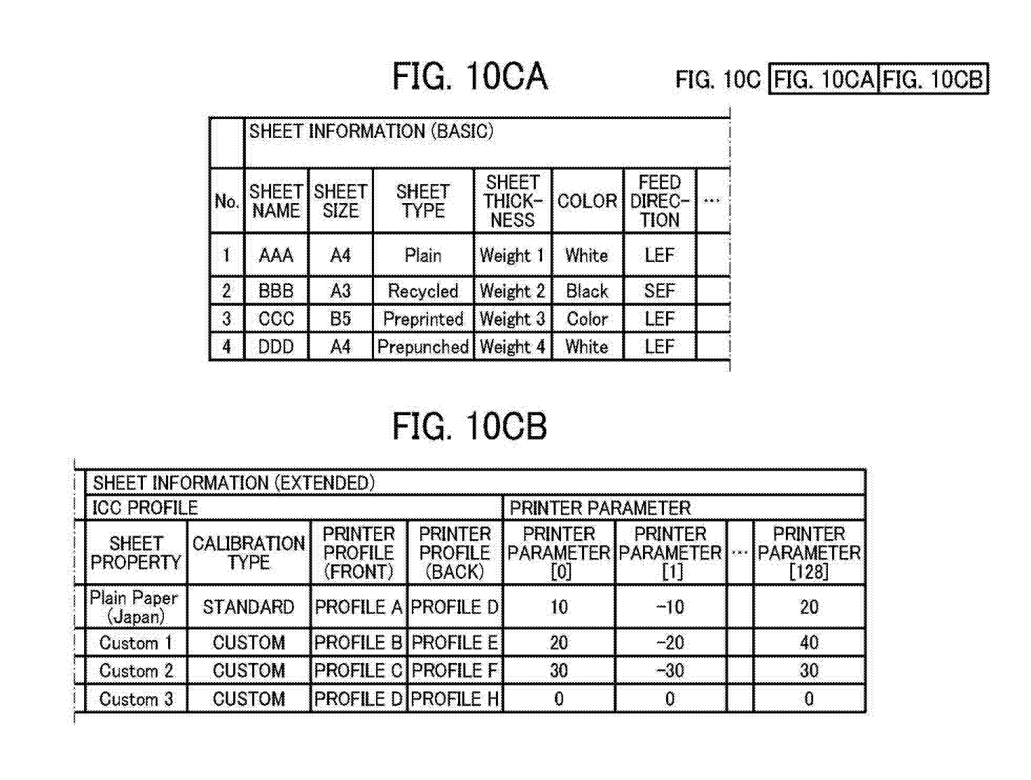

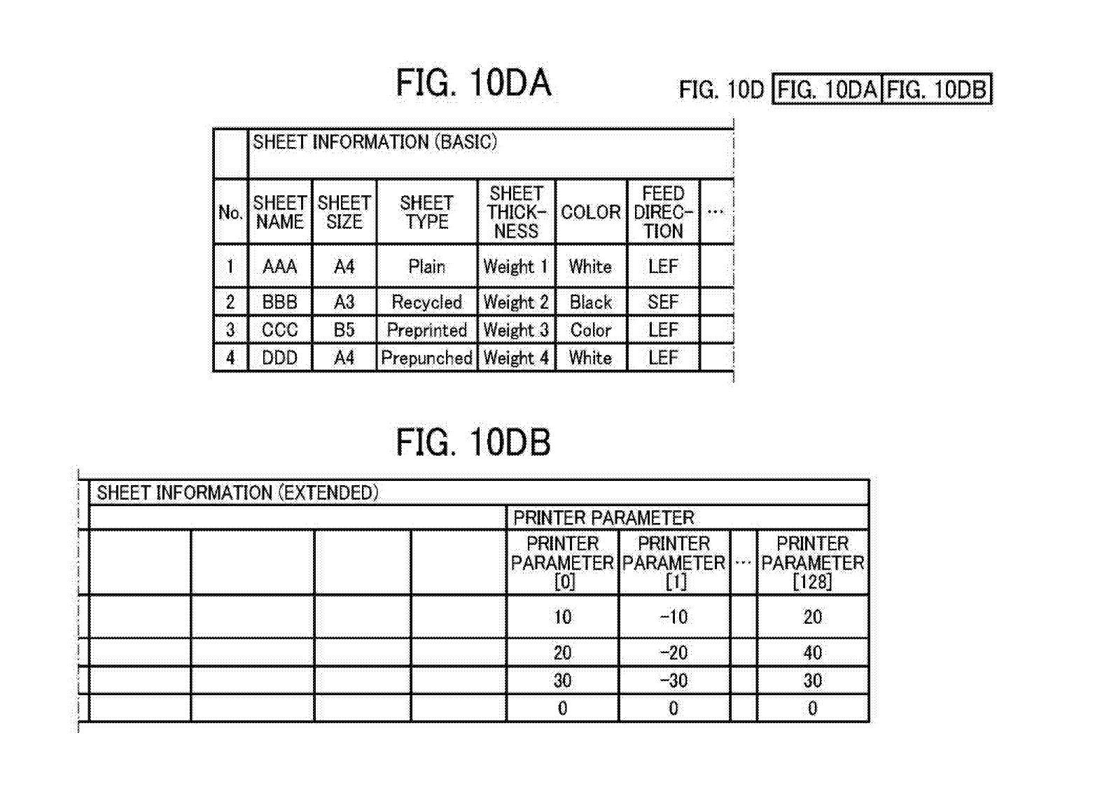

Next, contents of the recording sheet information stored in the print control apparatus 30 and the printer 50 is described, in case of synchronizing based on the sheet information stored in the print control apparatus 30. FIG. 10A illustrates sheet information stored in the print control apparatus 30 before synchronization, FIG. 10B illustrates sheet information stored in the printer 50 before synchronization, FIG. 10C illustrates sheet information stored in the print control apparatus 30 after synchronization, and FIG. 10D illustrates sheet information stored in the printer 50 after synchronization.

Referring to FIGS. 10A and 10B, before synchronizing between the recording sheet DBs 3001 and 5001, the basic recording sheet information includes the entries with the same sheet names “AAA”, “BBB”, and “CCC”, for both of the recording sheets DB 3001 and 5001. These entries are different in basic recording sheet information and printer parameter information. As illustrated in FIGS. 10C and 10D, after synchronizing between the recording sheet DBs 3001 and 5001, for the entries with the sheet names “AAA”, “BBB”, and “CCC”, the basic recording sheet information is synchronized while reflecting the basic recording sheet information of the print control apparatus 30.

Since the sheet name “DDD” of the print control apparatus 30 is not included in the sheet information of the printer 50, after synchronization (S707), the entry with the sheet name “DDD” is added to the recording sheet information of the printer 50. Since the sheet name “EEE” of the printer 50 is not included in the sheet information of the print control apparatus 30, after synchronization (S706), the entry with the sheet name “EEE” is deleted from the recording sheet information of the printer 50.

For the entry with the sheet name “AAA”, the sheet information matches between the print control apparatus 30 and the printer 50 in the basic recording sheet information, but does not match only in the printer parameter information. Accordingly, after synchronization (S705), the printer parameter information of the print control apparatus 30 for the sheet name “AAA” is updated based on the printer parameter information of the printer 50. Similarly, after synchronization, the printer parameter information for the entires with the sheet names “BBB” and “CCC” is updated to reflect the printer parameter information of the printer 50.

Now, operation of synchronizing the recording sheet information between the print control apparatus 30 and the printer 50, performed by the print system 1, is described according to the embodiment. FIG. 11 is a flowchart illustrating operation of synchronizing the recording sheet information based on the recording sheet information for the printer 50.

At S901, the sheet information comparator 36 obtains a sheet name of the recording sheet in the recording sheet information stored in the printer 50. At S902, the sheet information comparator 36 determines whether the sheet name exists in the sheet information stored in the print control apparatus 30, which is the same as that of the sheet information stored in the printer 50. When the recording sheet information of the print control apparatus 30 includes an entry with the sheet name that is the same as the sheet name of the recording sheet information of the printer 50 (“YES” at S902), the operation proceeds to S903. At S903, the sheet information synchronizer 34 overwrites the sheet information of the printer 50, with the sheet information of the print control apparatus 30 for that entry.

Referring back to S902, when the sheet information of the print control apparatus 30 does not have an entry with the same sheet name as that of the sheet information of the printer 50 that is obtained at S901 (“NO” at S902), the operation proceeds to S904. At S904, the sheet information synchronizer 34 newly adds the entry of the sheet information of the printer 50, which is not found in the sheet information of the print control apparatus 30, as an entry of the sheet information of the print control apparatus 30. For the sheet information of the print control apparatus 30 that is newly added at S904, the ICC profile setting information includes default values. S901 to S903, or S901 to S904, is performed for each one of the entries of the sheet information obtained from the printer 50.

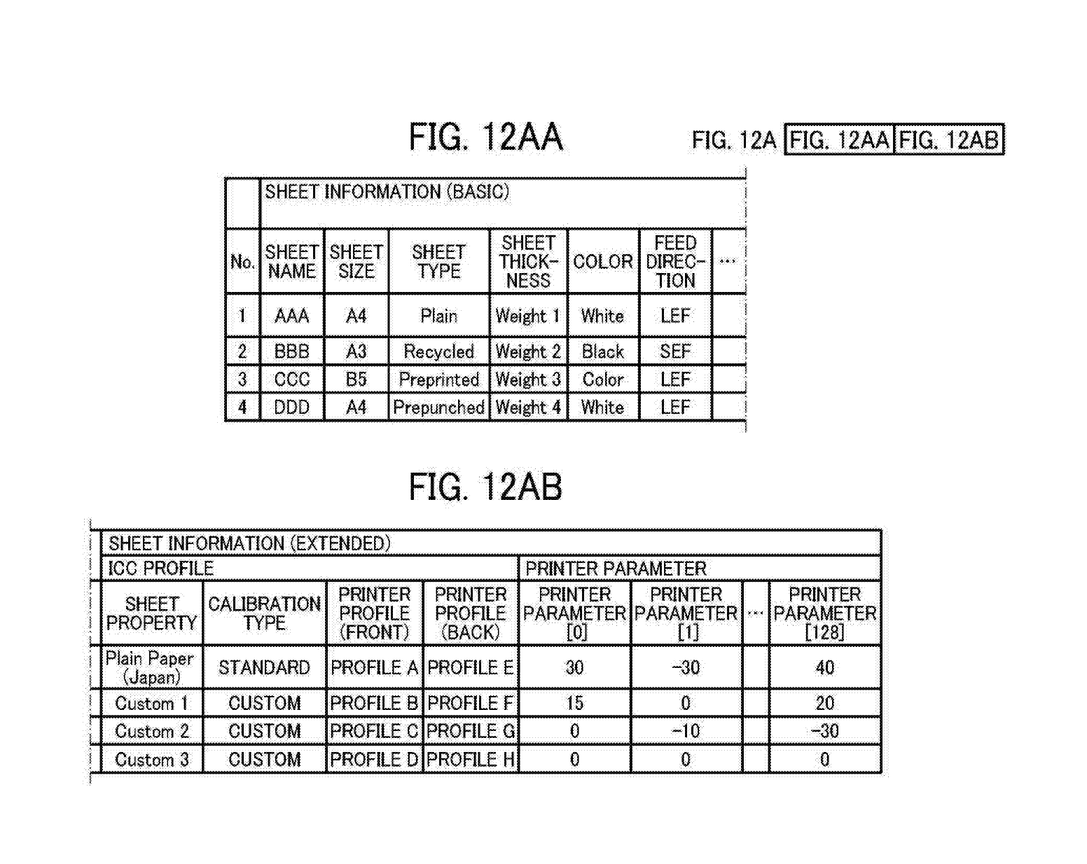

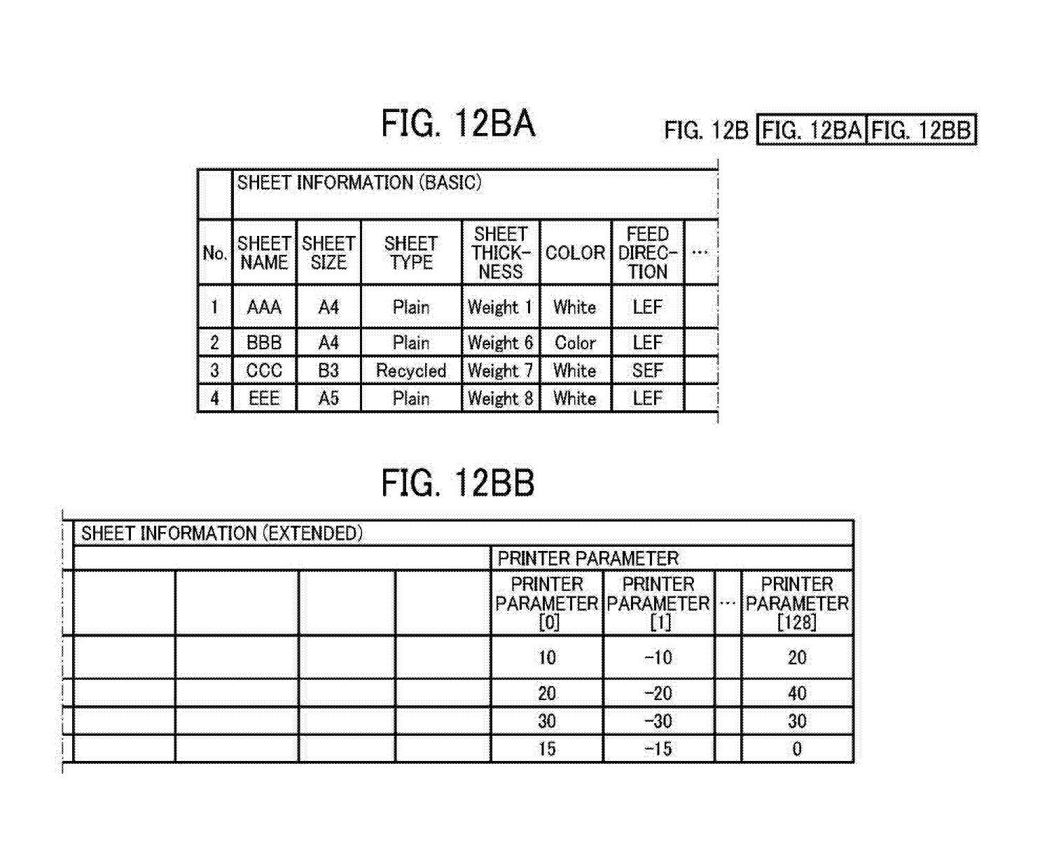

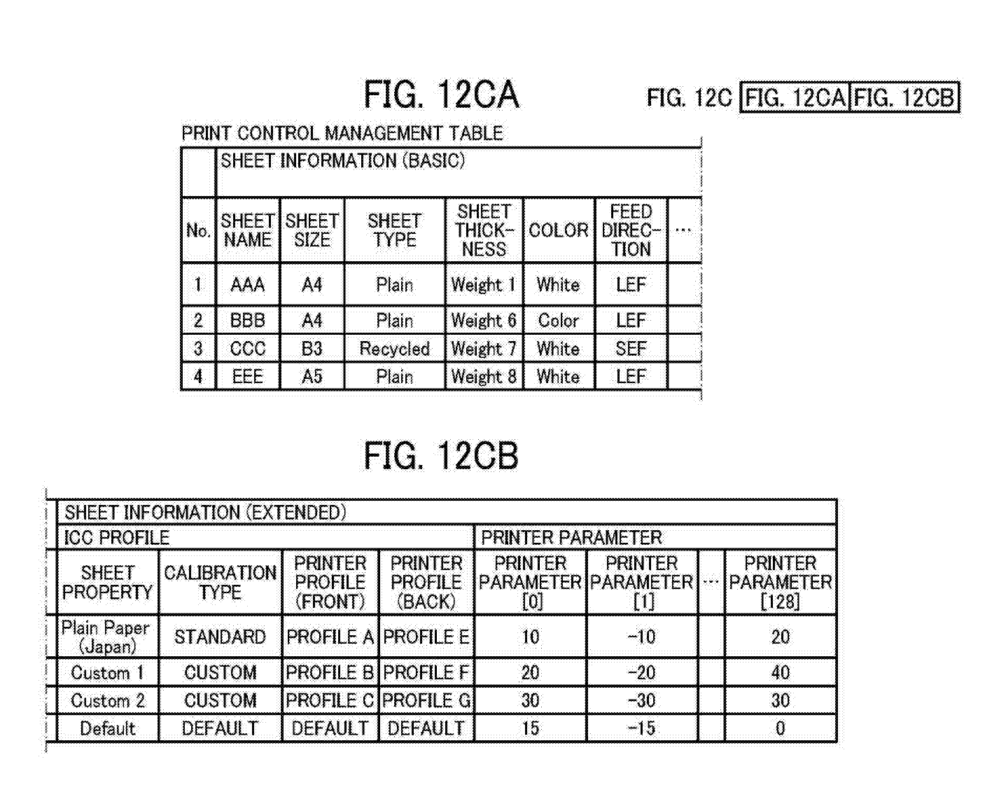

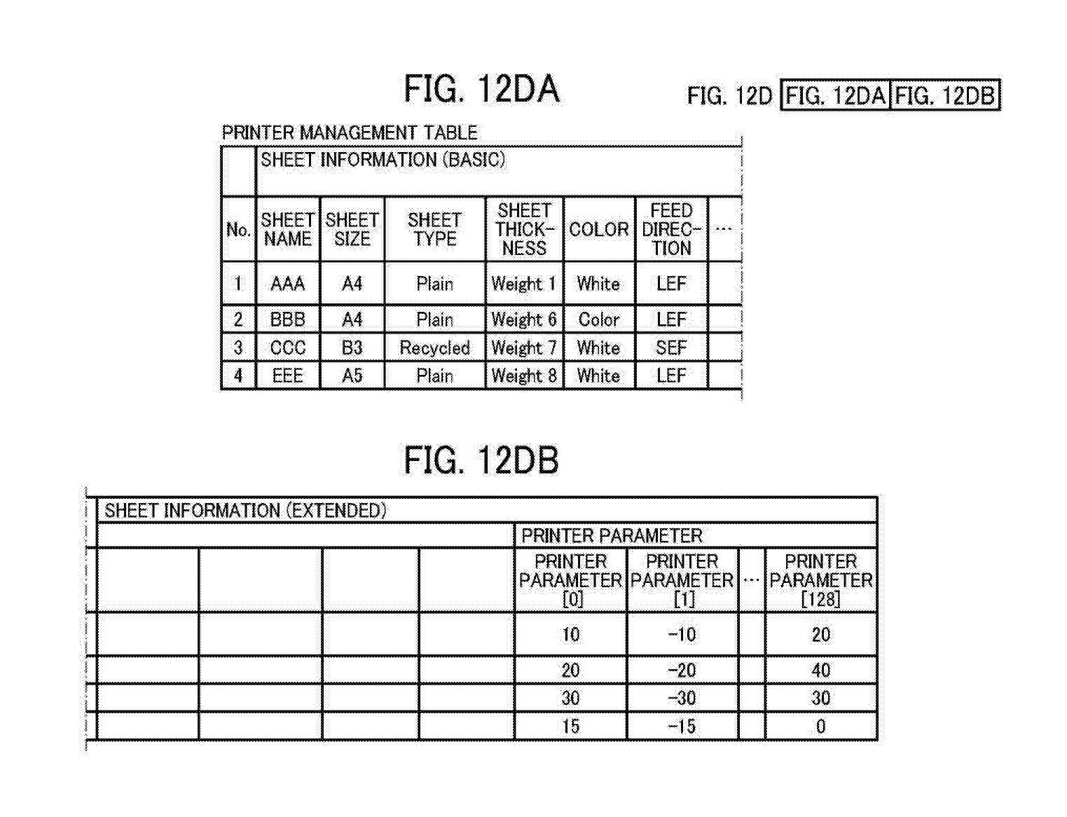

Next, contents of the recording sheet information stored in the print control apparatus 30 and the printer 50 is described, in case of synchronizing based on the sheet information stored in the printer 50. FIG. 12A illustrates sheet information stored in the print control apparatus 30 before synchronization, FIG. 12B illustrates sheet information stored in the printer 50 before synchronization, FIG. 12C illustrates sheet information stored in the print control apparatus 30 after synchronization, and FIG. 12D illustrates sheet information stored in the printer 50 after synchronization.

Referring to FIGS. 12A and 12B, before synchronizing between the recording sheet DBs 3001 and 5001, the basic recording sheet information includes the entries with the same sheet names “AAA”, “BBB”, and “CCC”, for both of the recording sheets DB 3001 and 5001. These entries are different in basic recording sheet information and printer parameter information. As illustrated in FIGS. 12C and 12D, after synchronizing between the recording sheet DBs 3001 and 5001, for the entries with the sheet names “AAA”, “BBB”, and “CCC”, the basic recording sheet information is synchronized while reflecting the basic recording sheet information of the printer 50.

Since the sheet name “DDD” of the print control apparatus 30 is not included in the sheet information of the printer 50, after synchronization, the entry with the sheet name “DDD” is deleted from the recording sheet information of the print control apparatus 30. Since the sheet name “EEE” of the printer 50 is not included in the sheet information of the print control apparatus 30, after synchronization, the entry with the sheet name “EEE” is added to the recording sheet information of the print control apparatus 30.

For the entry with the sheet names “AAA”, “BBB”, and “CCC”, the sheet information does not match between the print control apparatus 30 and the printer 50 in the printer parameter information. Accordingly, after synchronization, the printer parameter information of the print control apparatus 30 for the sheet name “AAA”, “BBB”, and “CCC” is updated based on the printer parameter information of the printer 50.

After the print control apparatus 30 and the printer 50 are synchronized in recording sheet information, at any time when contents of the recording sheet DB 3001 or 5001 changes, the print control apparatus 30 or the printer 50 may transmit a notification indicating the changed content to an information processing apparatus that is previously determined. The notification may be sent in the form of email data, with information regarding the contents before change and after change.

As described above, the recording sheet information is compared between the print control apparatus and the printer, and synchronized in case there is a difference, for example, in the basic recording sheet information such as the sheet size, sheet type, the thickness, etc.

Further, in addition to the basic recording sheet information such as the sheet size, sheet type, thickness, etc., the extended recording sheet information such as the ICC profile setting information and the printer parameter information can be synchronized between the print control apparatus and the printer. This allows the print system 1 to perform printing as defined by the user.

More specifically, when the sheet information that is previously set by a property of an image to be printed differs between the print control apparatus and the printer, the unmatched sheet information is corrected based on either one of the sheet information.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

For example, while the above-described embodiment only illustrates the case where one image forming apparatus (printer 50) is provided, the print system 1 may be provided with any desired number of printers 50. In such case, the print control apparatus 30 manages recording sheet information for each one of the printers 50, for example, with a printer ID assigned to each printer.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

In case of implementing with a program, such program may be stored in a ROM or any other nonvolatile recording medium such as a flash memory or EEPROM of a programmable device, or any removable medium such as a memory card, CD, DVD, or blue-ray disc. Alternatively, such program may be downloaded from an external device such as a storage server storing such program, to be installed on the programmable device.

1. An image forming control apparatus coupled to an image forming apparatus through a network and configured to control the image forming apparatus to form an image, the apparatus comprising:
a memory to store first recording medium information including, for each one of a plurality of entries of recording medium to be formed with an image, basic recording medium information that is previously determined by a type of recording medium and extended recording medium information that is previously determined by property of the image to be formed on the recording medium; and
circuitry to:
obtain second recording medium information from the image forming apparatus, the second recording medium being stored in a memory of the image forming apparatus and including for each one of a plurality of entries of recording medium to be formed with an image, basic recording medium information that is previously determined by a type of recording medium and extended recording medium information that is previously determined by property of the image to be formed on the recording medium;
compare between the first recording medium information and the second recording medium information to generate a comparison result; and
synchronize between the first recording medium information and the second recording medium information, based on the comparison result indicating that the first recording medium information and the second recording medium information do not match with each other.

2. The image forming control apparatus of claim 1,
wherein, when the comparison result indicates that the first recording medium information and the second recording medium information do not match with each other, the circuitry further controls a user interface to output a notification requesting a user to select either one of the first recording medium information and the second recording medium information,
wherein, in response to selection of the first recording medium information, the circuitry requests the image forming apparatus to modify the second recording medium information so as to match the first recording medium information for at least the basic recording medium information, and
wherein, in response to selection of the second recording medium information, the circuitry modifies the first recording medium information so as to match the second recoding medium information for at least the basic recording medium information.

3. The image forming system of claim 2, wherein the circuitry modifies the first recording medium information so as to match the second recording medium information for the extended recording medium information, irrespective of the selection of either one of the first recording medium information and the second recording medium information.

4. The image forming system of claim 3, wherein the extended recording medium information of the first recording medium information and the extended recording medium information of the second recording medium information each include image forming parameter information indicating parameter values to be used by the image forming apparatus in forming the image.

5. The image forming system of claim 3, wherein the basic recording medium information includes, for each one of the plurality of entries of recording medium, an identifier of the recording medium,
wherein, when the comparison result indicates that the first recording medium information has a recording medium entry with the identifier that is the same as an identifier of one recording medium entry included in the second recording medium information,
the circuitry synchronizes between the first recording medium information and the second recording medium information for the recording medium entry having the same identifier, based on the selected one of the first recording medium information and the second recording medium information.

6. The image forming system of claim 5,
wherein, when the comparison result indicates that the second recording medium information has a recording medium entry with the identifier that is not included in the first recording medium information,
the circuitry transmits, to the image forming apparatus, a request for deleting from the second recording medium information the recording medium entry with the identifier that is not included in the first recording medium information, in response to the selection of the first recording medium information, and
the circuitry modifies the first recording medium information so as to include the recording medium entry of the second recording medium information having the identifier that is not included in the first recording medium information, in response to the selection of the second recording medium information.

7. The image forming system of claim 5,
wherein, when the comparison result indicates that the first recording medium information has a recording medium entry with the identifier that is not included in the second recording medium information,
the circuitry transmits, to the image forming apparatus, a request for adding to the second recording medium information the recording medium entry with the identifier that is not included in the second recording medium information, in response to the selection of the first recording medium information, and
the circuitry modifies the first recording medium information so as to delete the recording medium entry having the identifier that is not included in the second recording medium information, in response to the selection of the second recording medium information.

8. An image forming system comprising:
the image forming control apparatus of claim 1; and
the image forming apparatus including the memory that stores the first recording medium information.

9. The image forming system of claim 8, wherein the image forming apparatus includes a plurality of image forming apparatuses.

10. The image forming system of claim 8, wherein the user interface is provided at least one of the image forming control apparatus and the image forming apparatus.

11. A method of controlling information to be used for forming an image, performed by an image forming control apparatus coupled to an image forming apparatus through a network, the method comprising:
storing, in a memory of the image forming control apparatus, first recording medium information including, for each one of a plurality of entries of recording medium to be formed with an image, basic recording medium information that is previously determined by a type of recording medium and extended recording medium information that is previously determined by property of the image to be formed on the recording medium;
obtaining second recording medium information from the image forming apparatus, the second recording medium being stored in a memory of the image forming apparatus and including for each one of a plurality of entries of recording medium to be formed with an image, basic recording medium information that is previously determined by a type of recording medium and extended recording medium information that is previously determined by property of the image to be formed on the recording medium;
comparing between the first recording medium information and the second recording medium information to generate a comparison result; and
synchronizing between the first recording medium information and the second recording medium information, based on the comparison result indicating that the first recording medium information and the second recording medium information do not match with each other.

12. The method of claim 11, wherein, when the comparison result indicates that the first recording medium information and the second recording medium information do not match with each other, the method further comprising:
outputting, through a user interface, a notification requesting a user to select either one of the first recording medium information and the second recording medium information,
wherein, in response to selection of the first recording medium information, the method further comprising requesting the image forming apparatus to modify the second recording medium information so as to match the first recording medium information for at least the basic recording medium information, and
wherein, in response to selection of the second recording medium information, the method further comprising modifying the first recording medium information so as to match the second recoding medium information for at least the basic recording medium information.

13. The method of claim 12, further comprising:
modifying the first recording medium information so as to match the second recording medium information for the extended recording medium information, irrespective of the selection of either one of the first recording medium information and the second recording medium information.

14. The method of claim 13, wherein the extended recording medium information of the second recording medium information includes image forming parameter information indicating parameter values to be used by the image forming apparatus in forming the image.

15. A non-transitory recording medium which, when executed by one or more processors, cause the processors to perform a method of controlling information to be used for forming an image with an image forming apparatus, the method comprising:
storing, in a memory of an image forming control apparatus, first recording medium information including, for each one of a plurality of entries of recording medium to be formed with an image, basic recording medium information that is previously determined by a type of recording medium and extended recording medium information that is previously determined by property of the image to be formed on the recording medium;
obtaining second recording medium information from the image forming apparatus, the second recording medium being stored in a memory of the image forming apparatus and including for each one of a plurality of entries of recording medium to be formed with an image, basic recording medium information that is previously determined by a type of recording medium and extended recording medium information that is previously determined by property of the image to be formed on the recording medium;
comparing between the first recording medium information and the second recording medium information to generate a comparison result; and
synchronizing between the first recording medium information and the second recording medium information, based on the comparison result indicating that the first recording medium information and the second recording medium information do not match with each other.
